(19) United States
(12) Patent Application Publication
(10) Pub. No.: US 2006/0022448 A1
(43) Pub. Date: Feb. 2, 2006

(54) Breakaway binding for publication with independent sections

(76) Inventor: Virginia Lee Bolton, Pickering (CA)

Correspondence Address: Dennison Associates;Suite 301, 133 Richmond Street West, Toronto, ON, M5H 2L7, CA

(21) Appl. No.: 10/900,372

(22) Filed: Jul. 28, 2004

(51) Int. Cl. B42D 1/00

(52) U.S. Cl. 281/15.1

(57) ABSTRACT

A printed publication having two or more separate sections is manufactured as a single print run but is easily separated by an end user for convenience of use or storage. The printed publication has an outer cover with separate sections adhesively secured thereto. Two inner covers separate each section and form a cover for a separated section. The outer cover includes a tear line between each section to assist in separating of the sections. The tear line is preferably a series of perforations or other arrangement to assist in a clean separation of the sections and the retained securement of each section with two covers. In the case of a two section publication, the covers of each section are part of the outer cover and one inner cover. In a three section publication, the intermediate section has two inner covers and a strip of said outer cover along a spine of the section.

### FIELD OF THE INVENTION

The present application is directed to printed publications and in particular, to printed publications which are divided into two different sections where the sections are commonly used independently of the other section. In addition, the invention is directed to a method of manufacturing such a publication.

### BACKGROUND OF THE INVENTION

Printed publications and in particular, printed publications such as manuals are commonly printed in two different languages such that two manuals are provided with the associated product. In some cases if the manual is relatively small with respect to the number of pages therein, a single manual is reversibly printed and bound to reduce the printing costs. As the size of the manual increases, it may be necessary to produce two separate manuals such that the user may discard one of the manuals. Unfortunately, two manuals substantially increases the packaging costs and printing costs. As can be appreciated, two separate printing runs are necessary and then the manuals are typically packaged together such that the user can maintain the appropriate manual and discard or otherwise store the inappropriate manual.

In order to save costs, it is known to reverse print two large manuals as a single manual, however, this has the disadvantage of increased size and less ease of use by the consumer. There are significant cost advantages in being able to manufacturing a single manual to be included with a product as opposed to multiple manuals to be included with a product.

The printing of manuals and in particular, the printing of manuals associated with multifunction electronic devices such as cell phones, personal organizers, cordless phones, televisions, radios, stereos, etc. often require manuals having a significant number of sheets where the manual published in two different languages is too bulky for convenient use by the user.

The present invention seeks to address a number of the deficiencies described above.

### SUMMARY OF THE INVENTION

A printed publication according to the present invention comprises an outer cover adhesively securing within the outer cover a series of sheets and a pair of inner covers. The adhered inner covers divide the sheets into a first section and a second section and the outer cover is adapted to be physically separated between the pair of inner covers. With this arrangement, the first and second sections are separable from one another and the pair of inner covers each form a secured cover of the first or second sections.

In a preferred embodiment of the invention, the pair of inner covers form back covers of the first and second sections and the outer cover forms the front cover of the respective first and second sections.

In yet a further aspect of the invention, the printed publication is a manual and preferably is a user manual for an electronic device having multiple functions.

In yet a further aspect of the invention, the outer cover is physically reduced in strength adjacent the inner covers to assist in tearing of the outer cover between the inner covers.

In yet a further aspect of the invention, the outer cover is physically weakened by a series of perforations to assist in tearing of the outer cover between said inner covers.

In yet a further aspect of the invention, the publication is a multi language manual and the first section is the manual in a first language and the second section is the manual in the second language.

In yet a further aspect of the invention, the manual is reverse printed where the outer cover has a first face forming a front cover in the first language of the first section and the outer cover has a second face forming a front cover in said second language of said second section.

In yet a further aspect of the invention, the inner covers are each associated with one of said sections to separate therewith and said inner covers each form a back cover for and in the language associated with the associated first or second sections.

In yet a further aspect of the invention, the publication is a manual published in three languages and includes a second pair of inner covers such that the inner covers divide the sheets into said first section, said second section and a third section, and each section defines a manual in a different language.

In yet a further aspect of the invention, the third section is located between said first and second sections and said second pair of covers is either side of third section and form a front and back cover for said third section.

In yet a further aspect of the invention, the outer cover includes two series of perforations for tearing of said publication between said sections to form three separate manuals.

### BRIEF DESCRIPTION OF THE DRAWINGS

Preferred embodiments of the invention are shown in the drawings, wherein:

FIG. 1 is a perspective view of a two section publication;

FIG. 2 is a partial end view of the two section publication;

FIG. 3 is a partial perspective view showing a two section publication being torn to separate one section from the other;

FIG. 4 shows the publication of FIG. 3 fully torn to define two separate sections, each having a front and back cover;

FIG. 5 is a perspective view showing the assembly of the different sections of the publication in preparation for the cover being applied thereto;

FIG. 6 is a perspective view of the sheets of the publication with an adhesive being applied to bind the sheets together;

FIG. 7 is a partial perspective view of a cover with a central perforation in a length thereof being secured to the series of sheets with the adhesive applied thereto;

FIG. 8 is a partial perspective view of a three section publication; and

FIG. 9 is a partial end view showing the three section publication where each section is removable from the other.

### DETAILED DESCRIPTION OF THE PREFERRED EMBODIMENTS

The printed publication 2 has been manufactured by what is commonly referred to a reverse printing operation where the outer cover 4 forms two front covers of the publication. The orientation of the printed publication is reversed depending upon what the user considers to be the preferred orientation. This reverse printing approach is commonly used for publications printed in two languages where the printed publication is essentially reversible. Manuals, instruction books, product guides, and handbooks, etc. are commonly printed in this manner.

The printed publication 2 has a series of sheets which are divided into a first section of sheets 6 and a second series of sheets 8. Secured between the first and second series of sheets is a pair of inner covers 10. Each inner cover forms a back cover for the associated first section or second section.

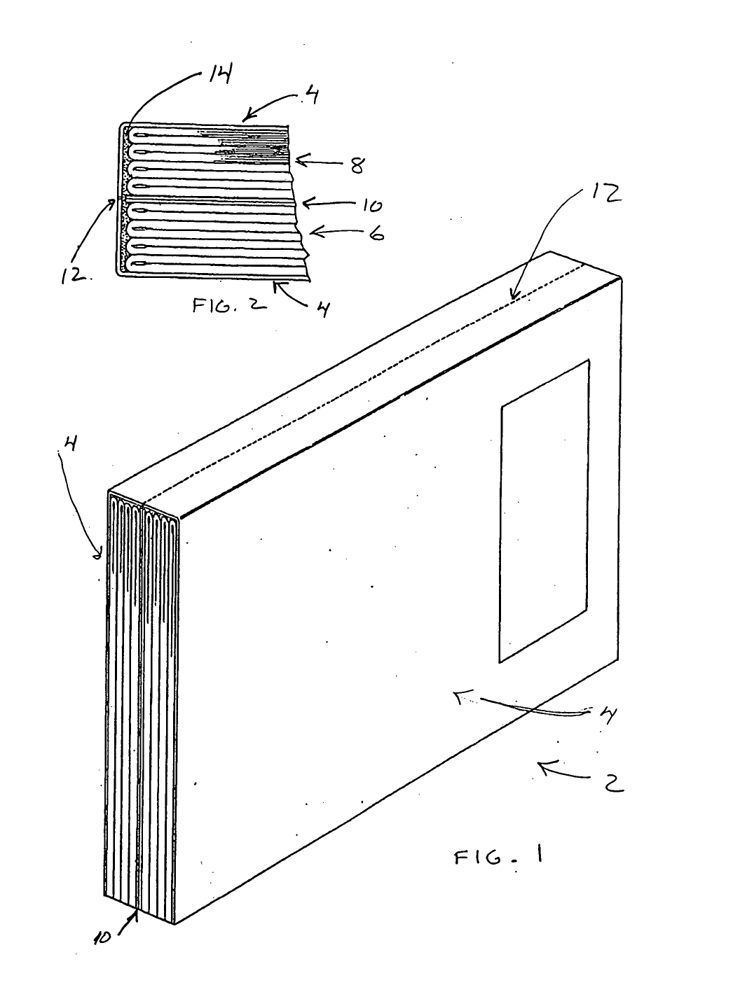

The outer cover 4 of the publication has been physically weakened to allow separation of the publication into two sections and in the embodiment shown in FIG. 1 as series of perforations 12 are provided in the outer cover and aligned with the pair of inner covers.

FIG. 3 shows a user physically separating the printed publication into two manuals 20 and 22. One of these manuals could be in English and the other manual could be in French or some other language. With this arrangement, the end user can merely separate the publication into the two or more manuals as will be subsequently described and maintain the appropriate manual for his own use. The inner covers 10 preferably form back covers of the separated manuals and serve to protect the sheets of the respective first or second sections.

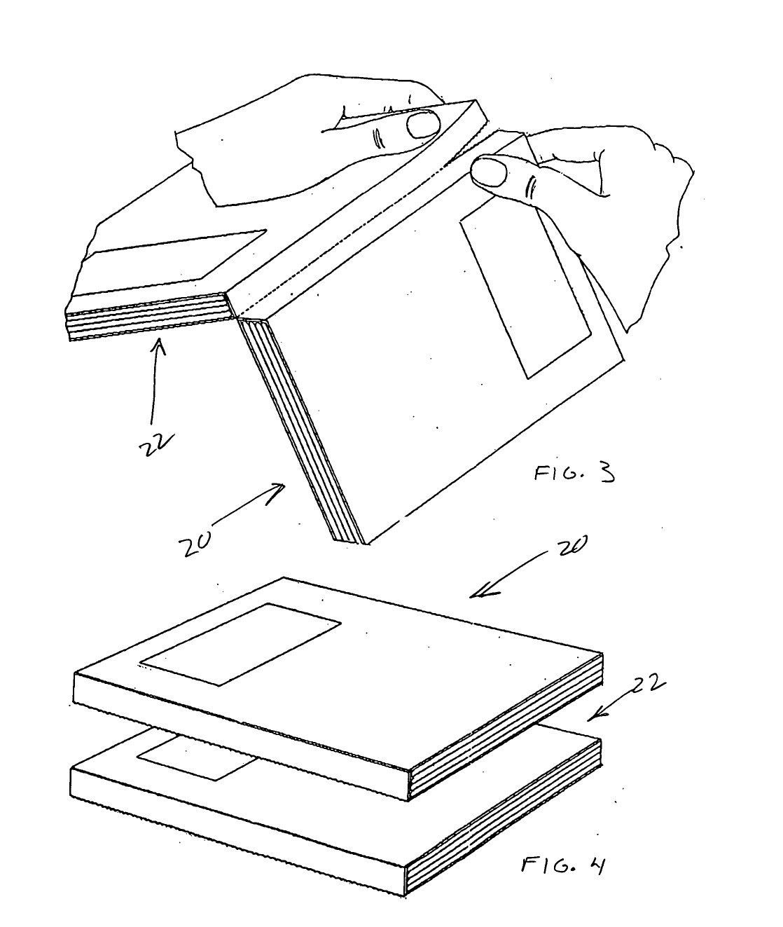

The pair of inner covers are adhesively secured with the first section of the sheets and the second section of the sheets to the outer cover by an adhesive 14 as shown in the sectional view of FIG. 2. The series of perforations 12 in the outer cover 4 is aligned with the pair of inner covers and allows separation of the publication in the manner shown in FIG. 3. With this arrangement, the inner cover remains secured to the portion of the outer cover that remains partially wrapped around the respective first or second section of the series of sheets. Preferably the inner covers are each separate sheets secured to the outer cover by the adhesive 14. This assists in tearing of the printed publication between the pair of inner covers. It is also possible to have the inner covers preprinted as a single sheet and weakened along what will become the tear line. This weakening can be in the form of scoring or perforations or other appropriate deformation to assist in tearing of the publication while maintaining the inner cover secured to the appropriate portion of the outer cover. The inner covers and the outer cover are of a paper stock weight at least several times greater than the paper stock weight of the printed sheets.

With this arrangement, the inner covers form back covers of the separated manuals and therefore a single manual may be produced as a single print run and merely separated by the user if desired in the manner shown. This significantly reduces the cost of producing the manual as a single print run is used. For example, the savings in printing a single publication defining two manuals as generally shown in the drawings versus the separate publication of two equivalent manuals is in the order of a 35%. A significant portion of this savings is attributed to reduced binding costs. The user may then decide which manual he wishes to maintain or in some cases may wish to maintain both copies of the manual. In this case he would not separate the manuals. In contrast, if he wishes to maintain only one of the manuals, he would tear them as indicated and only use the pertinent manual.

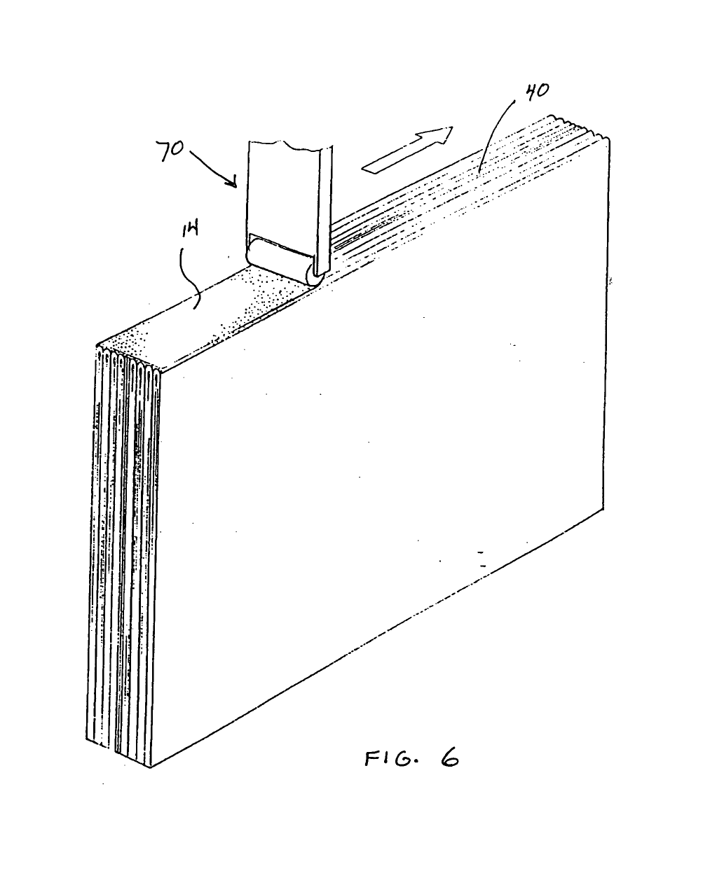

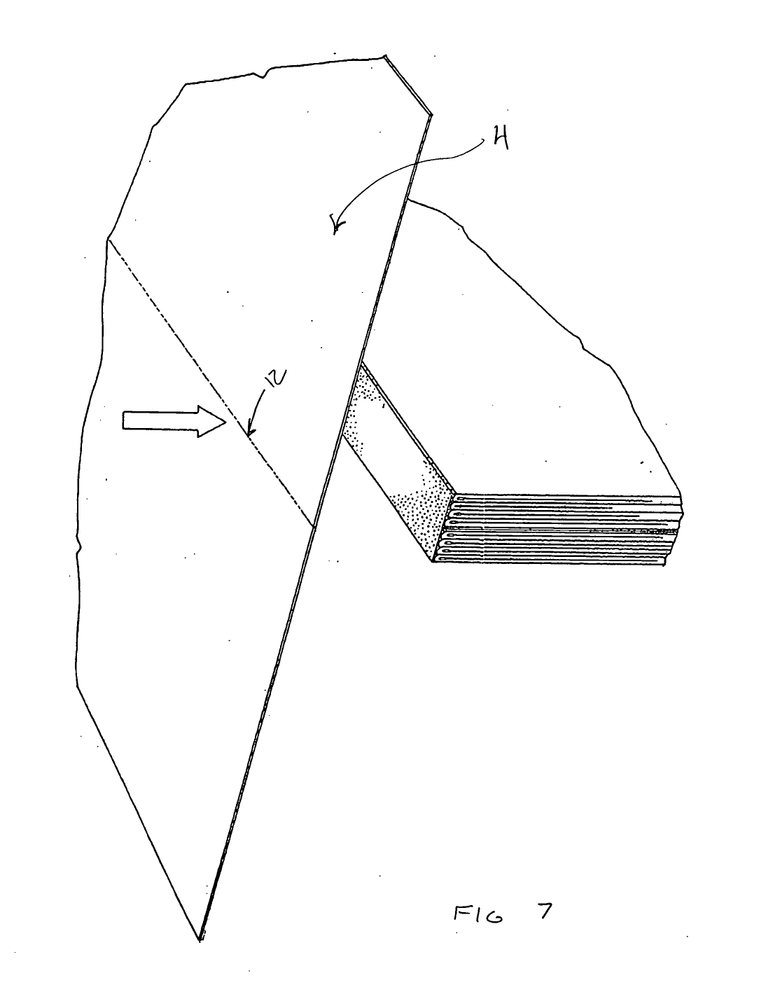

The general method of assembling the printed publication is shown in the drawings of FIGS. 5, 6 and 7. In this case, the series of sheets 30 form the first section 6 and the series of sheets 32 form the second section 8. Disposed between the first section 6 and the second section 8 is the pair of inner covers 10 where the upper inner cover will form the back cover for the first section 6 and the lower inner cover will form the back cover for the second section 8. Once these have been organized as indicated in FIG. 5, they may be brought together and an adhesive applied to the spine 40.

The adhesive 14 is applied to the spine 40 in FIG. 6 using a roller applicator generally shown as 70. Other methods for applying the adhesive may be used.

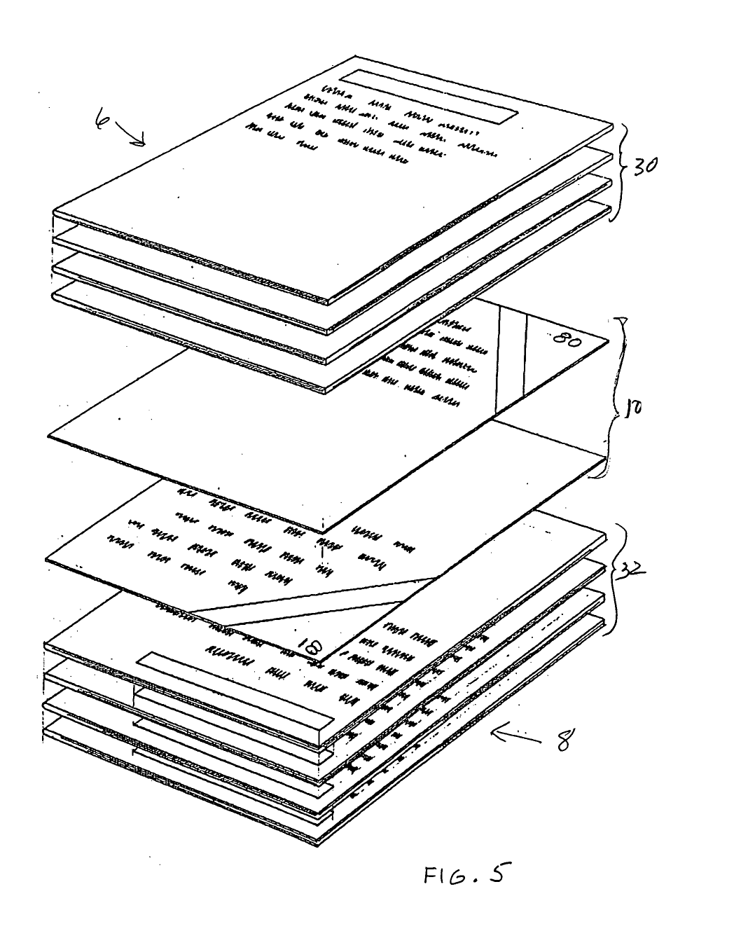

The adhesive 14 is preferably a flexible adhesive which will maintain the various sheets together while allowing tearing of the adhesive necessary for separation of the publication into the two bound manuals shown in FIG. 4. Once the adhesive 14 has been applied along the spine 40, the outer cover 4 having the series of perforations 12 is applied and secured to the publication by means of the adhesive 14. The series of perforations are aligned with the pair of inner covers. Preferably the adhesive 14 is a hot melt type adhesive which retains its flexibility and allows for separation in the length of the publication as indicated. Further suitable adhesives used in perfect binding include EVA (ethylene vinyl acetate), hot-melts, PVA (polyvinyl acetate), cold emulsion adhesives, and PUR (polyurethane reactive) hot-melts.

Other methods for weakening of the outer cover to allow tearing to form the two different sections are also possible. For example, the outer cover could be deeply scored to promote tearing in this area. It is also possible to apply the adhesive 14 in other forms other than the roller 43 shown. This arrangement is merely to demonstrate one method of applying the adhesive although other known methods may also be suitable. The amount of the adhesive can be appropriately varied depending upon the particular properties of the adhesive to allow for the separation of the publication into the two sections while maintaining securement of the first and second series of sheets and the retention of the inner covers with the appropriate sections.

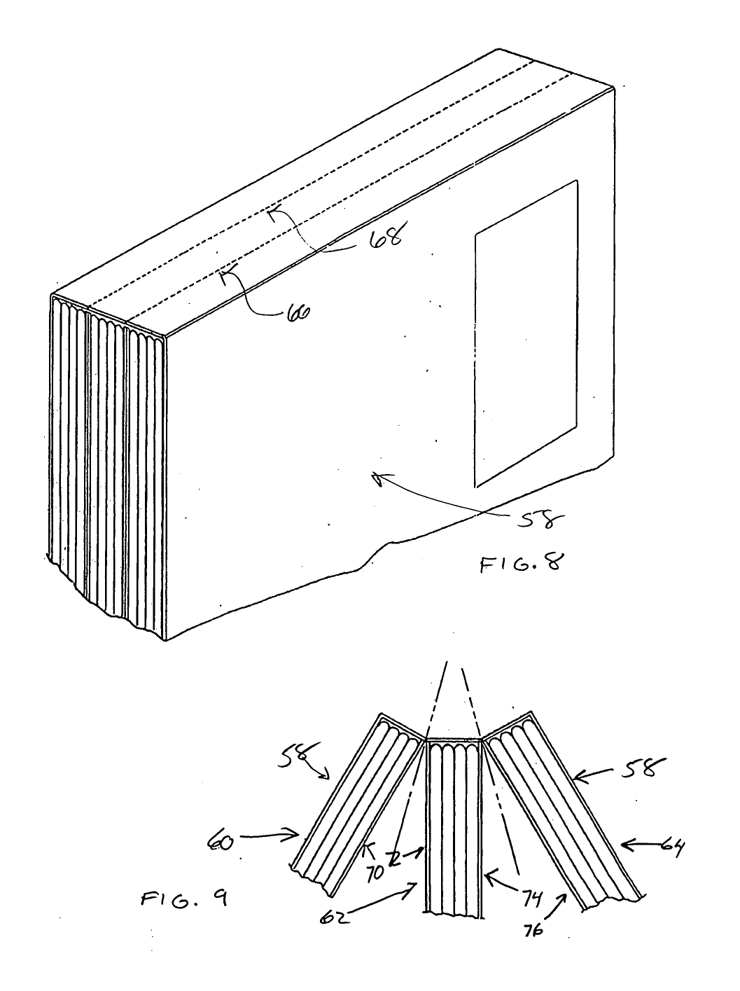

FIGS. 8 and 9 show a further variation of the printed publication which is separable into three separate sections shown as 60, 62 and 64. In this case, two series of perforations 66 and 68 are provided in the outer cover and four inner covers 70, 72, 74 and 76 are provided. With the arrangement as shown in FIGS. 8 and 9, the inner covers 72 and 74 will form the front and back covers for the manual 62 whereas the outer cover 58 will form the front covers for the manual 60 and 64. The outer cover 58 has the two series of perforations 66 and 68. The inner covers 70 and 76 will form the back covers for the manual 60 and 64 respectively. With this arrangement, a three language manual can be manufactured in a single print run and the manuals can be physically separated by tearing of the individual sections one from the other as indicated in the two section separation shown in FIG. 3.

The inner covers have been described as separate sheets which are adhesively secured within the printed publication. These inner covers are preferably of a heavier paper stock similar to the outer cover and thus provides an excellent finished product. It is possible that these inner covers are of a single sheet and are merely physically weakened at the join therebetween to promote the separation of the printed publication into the two or more sections. It is also possible that the inner covers could be of a slightly reduced paper stock quality or the same paper stock as the printed sheets if the subsequent reduction in the quality of the manual is satisfactory.

It can be appreciated that in order to provide a manual of good quality, the perforations 66 and 68 and the perforation or weakening 12 shown in the earlier Figures, can severely weaken the outer cover. This is satisfactory as the purpose of the cover is merely to allow publication and subsequent binding as part of a single run or more cost effective run and it is intended that the publication will in most cases be separated into individual separate sections.

The printed publication is particularly suitable for user manuals associated with electronic devices having multiple functions. For example, a manual associated with a cell phone has upwards of 50 or more pages to describe the different functioning and programming that is possible. Such a manual produced as a single publication in two languages, is indeed a bulky manual and the manual itself is often at least twice the size of the actual cell phone. As additional functions are provided to the cell phone such as a personal organizer, camera, contact list or other calling features, the size of the manual continues to increase.

The present invention allows such manuals to be easily manufactured in a manner to maintain a relatively low printing cost while allowing the user to reduce the size of the manual if he determines that not all languages are required.

In the preferred embodiment, the printed publication is produced in a manner to be separated by the end user. It is also possible to separate the manuals as part of the production process. In this case, the manuals can be wrapped together or otherwise grouped, if desired. This grouping can be used for packaging of the publication with a product. As can be appreciated, the advantages in the printing and binding process are realized and separate manuals are provided for product applications. In some cases, such sections of the printed publication can be produced as essentially separate manuals leaving only small weakened sections ready for the final separation by the user.

Although the invention has been specifically described and has immediate application with respect to user manuals, it is also appropriate for other publications where there is a need to produce two or more different sections where only one of these sections may be required by the end user. Therefore, the present invention has application with respect to manuals guide books, catalogues, handbooks, instruction books, and other publications of this type.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A publication comprising an outer cover adhesively securing interior to said cover a series of sheets, a pair of inner covers adhesively secured to said outer cover and dividing said sheets into a first section and a second section, and wherein said outer cover is adapted to be physically separated between said pair of inner covers whereby said first and second sections are separated and said pair of inner covers form a secured cover of said first and second sections.

2. A publication as claimed in claim 1 wherein said pair of inner covers form back covers of said first and second sections.

3. A publication as claimed in claim 2 wherein said printed publication is a manual.

4. A publication as claimed in claim 1 wherein said printed publication is a user manual for an electronic device having multiple functions.

5. A publication as claimed in claim 1 wherein said outer cover is physically reduced in strength adjacent said inner covers to assist in tearing of said outer cover between said inner covers.

6. A publication as claimed in claim 5 wherein said outer cover is physically weakened by a series of perforations to assist in tearing of said outer cover between said inner covers.

7. A publication as claimed in claim 6 wherein said printed publication is a user manual for an electronic device having multiple functions.

8. A publication as claimed in claim 7 wherein said inner covers are separate sheets.

9. A publication as claimed in claim 7 wherein said inner covers are a common sheet perforated to allow separation thereof.

10. A publication as claimed in claim 7 wherein said inner covers are part of a common sheet physically weakened to allow separation of said covers during separation of said outer cover.

11. A publication as claimed in claim 5 wherein said publication is a multi-language manual and said first section is the manual in a first language and said second section is said manual in a second language.

12. A publication as claimed in claim 11 wherein said manual is reverse printed where said outer cover has a first face forming a front cover in said first language of the first section and said cover has a second face forming a front cover in said second language of said second section.

13. A publication as claimed in claim 12 wherein said inner covers are each associated with one of said sections to separate therewith and said inner covers each form a back cover for and in the language of the associated first or second sections.

14. A publication as claimed in claim 1 wherein said publication includes a second pair of inner covers such that said inner covers divide said sheets into said first section, said second section and a third section and each section defines a manual in a different language.

15. A publication as claimed in claim 14 wherein said cover includes two tear regions allowing separation of each section between a pair of said inner covers.

16. A publication as claimed in claim 1 wherein said outer cover is at least partially cut between said inner covers.

17. A publication comprising a first cover, a series of printed sheets and a separate second cover, said first cover including an end segment adhered to said series of printed sheets along an edge of said printed sheets, said separate second cover along an edge thereof being adhesively secured to said end segment of said first cover.

18. A publication as claimed din claim 17 wherein said first cover and said second cover are of a paper stock weight at least several times greater than the paper stock weight of said printed sheets.

19. A method of manufacturing a printed publication being at least two distinct sections adapted to be physically separated are from the other comprising steps of placing a pair of inner covers intermediate a series of printed sheets;
adhesively securing the printed sheets and inner covers within an outer cover, wherein said outer cover includes a cut or tear line intermediate said inner covers to allow separation of said publication between said inner covers into two sections with each inner cover cooperating with a portion of said outer cover to provide front and back covers for the portion of the series of printed sheets therebetween.

20. A method as claimed in claim 19 wherein said method includes as part of the method of manufacture, the physical separation of the publication into two sections.
